(19) United States
(12) Patent Application Publication
(10) Pub. No.: US 2003/0081162 A1
(43) Pub. Date: May 1, 2003

(54) Photo-alignment of liquid crystals

(76) Inventor: Richard J Miller, Malvern (GB)

Correspondence Address: Nixon & Vanderhye, 8th Floor, 1100 North Glebe Road, Arlington, VA, 22201-4714, US

(21) Appl. No.: 10/148,680

(22) PCT Filed: Nov. 29, 2000
(86) PCT No.: PCT/GB00/04530

(30) Foreign Application Priority Data
Dec. 1, 1999 (GB) 9928283.2

(51) Int. Cl. G02F 1/1337

(52) U.S. Cl. 349/129

(57) ABSTRACT

An alignment layer on a first substrate (1) comprises a material which can be altered from a first to a second state by the action of incident light (5) of at least a first wavelength, the first and second states causing adjacent portions of a liquid crystal layer (3) to tend to adopt corresponding different first and second alignments. As the alignment layer is altered from its first to its said second state, realignment of the liquid crystal is facilitated by changing its ordering out of the first alignment, for example by applying an electric field (as shown from in-plane electrodes (7)), or by disrupting the liquid crystal ordering. The alignment layer may comprise a Schiff base, azo dye or a stilbene which can effectively realign in response to incident polarised light producing cis-trans isomerisation therein. The liquid crystal layer may be locally realigned by local optical and/or electrical addressing (as shown from (a) to (c) a local beam (5) alters the planar alignment direction at substrate (1)).

The present invention relates to apparatus and methods for optically controlling the local alignment of a liquid crystal phase disposed adjacent a substrate, or the state of a liquid crystal alignment layer adjacent a liquid crystal layer.

The advent of compact laser sources and the widespread use of read only optical data storage has led to the need for recordable optical data storage media. Due to their optical and other physical properties, in particular their high birefringence, the relative ease with which such birefringence can be manipulated, and the fact that there has already been considerable development of devices in the fields of optical modulation and displays, liquid crystal materials are regarded as good candidates for optical data storage.

A number of optically addressable information storage devices have been developed which can exhibit greyscale or analogue storage capability at each pixel. Optical addressing has the potential to drastically increase the pixel density compared with conventional electrically addressed devices. In addition to the pure storage of information, such devices are potentially useful in other applications, for example very high information/resolution displays, where it may become increasingly impractical to address individual pixels electrically; holographic displays where the necessary number of pixels may be of the order of 10¹², as opposed to, say, 10⁶ for what would be regarded as a good or high resolution conventional display; as optical components such as in correcting for optical aberration in optical instruments for example telescopes; image recognition systems, and neural networks.

The use of an alignment layer, conventionally on a substrate, to influence the alignment of the adjacent liquid crystal material is well known. Often these layers once formed are intended to remain in the same state for the lifetime of the devices incorporating them. Typical examples include rubbed surfaces, thin layers formed by oblique vapour deposition, and layers comprising orientated anisotropic molecules or moieties.

Liquid crystal devices which incorporate a dye are also well known. An example is the guest-host effect type of device, but there are also devices where the dye undergoes a change on being subject to optical illumination.

For the purpose of the present specification the term “dye” will henceforth be used to cover a dye or other similar material, not necessarily visibly coloured, with optically anisotropically absorbing molecules—useful materials tend to be non-ionic dichroic materials which absorb at some useful wavelength, for example in the visible or near ultra-violet.

For example, a dye which comprises an azo link will normally have a low energy trans isomer and a higher energy cis isomer. Similar changes would be expected with stilbenes or Schiff bases. The double bond of the azo link will absorb light at wavelengths in or close to the visible range, but preferentially for light polarised in one direction relative to the double bond. In the excited state the molecule can undergo a series of changes resulting in conversion to the cis isomer.

Resulting relaxation to the energetically favourable trans isomer can lead to a molecular alignment similar to the initial alignment, or to an alignment which is effectively rotated relative to the initial alignment. Under isotropic conditions, there is nothing to distinguish the initial and rotated alignments, but with polarised illumination one of the alignments of the trans isomer preferentially absorbs light, eventually leading to the majority of molecules ending up with a trans orientation that minimises the absorption of the incident polarised light.

A typical sequence of events is illustrated schematically in FIG. 5, in which (a) shows a dichroic azo dye molecule in its original alignment in the energetically favoured trans state, and (b) shows the higher energy cis state arising from absorption of polarised light hν₁. Via any of a number of mechanisms including thermal and radiative mechanisms (hν₂) the molecule (b) may revert to the original state (a) or may proceed to a trans state in which the direction of the long molecular axis has effectively rotated (although as shown this is not a true rotation in the plane of the paper, the reader will appreciate that rotation of the molecule about the long axis is energetically relatively easy, and whether or not this occurs is in any case irrelevant in relation to the liquid crystal alignment to be induced).

Thus the orientation of the dye molecules can be optically controlled, and by incorporating such molecules in a liquid crystal material it is possible to control, or at least apply a torque for controlling, the orientation of the liquid crystal molecules. However, the change in orientation of the liquid crystal material tends to be impermanent.

Alternatively, the dye may be incorporated in, or form, a liquid crystal alignment layer adjacent the liquid crystal material, in which case the alignment change in both the alignment layer and the adjacent liquid crystal material is more permanent. A typical such alignment layer comprises the optically absorbing moieties secured to a substrate, for example being covalently linked to an alkyl chain itself linked to the substrate by a siloxane group, or extending from the backbone of a polymeric material coated on the substrate, for example by spin coating. Examples thereof will be found in the prior art, including at least some of the specifications listed in the following paragraph.

Disclosures of devices incorporating these prior art arrangements of realignable dyes will be found in U.S. Pat. Nos. 5,856,431; 5,856,430; 5,846,452; 5,817,743; 5,807,498; 5,731,405; and 5,032,009, all in the name of Gibbons et al. These devices comprise a liquid crystal layer between spaced substrates, wherein a substrate is provided with an alignment layer including optically anisotropically absorbing molecules or moieties.

However, devices with typical reported photo-alignment layers comprising a dye commonly require a polarised optical input of the order of at least 1 Joule/cm², and often around 10 Joule/cm² to cause re-alignment of the dye molecules and consequential re-orientation of an adjacent liquid crystal phase.

It is believed that this high power requirement is due to the reverse interaction between the liquid crystal phase and the dye, particularly when it is remembered that while re-orientation of the dye molecules per se is close to a surface or single layer effect, the forces involved with reorientation of the adjacent liquid crystal phase extend into the bulk liquid crystal layer. Indeed, it has been found that the optical power density necessary to re-align the dye layer in the absence of a liquid crystal material, or in the presence of a liquid crystal material heated above its clearing temperature, can be reduced by around two orders of magnitude to about 10 mJ/cm², or even lower near the clearing (isotropic) temperature of the liquid crystal material. See, for example, K Ichimura et al, “Command Surfaces 12[1]. Factors Affecting In-plane Photoregulation of Liquid Crystal Alignment by Surface Azobenzenes on a Silica Substrate”, Liquid Crystals, 20 (1996) 423-435. Neither of these approaches is practical when operating a photo-addressed liquid crystal device.

A consequence of the high optical input requirement of the reported devices is that the dyes tend to bleach permanently over a relatively short period of use, so reducing the lifetime of the devices incorporating them

Thus there remains a requirement for a photo-addressed liquid crystal arrangement which involves a low optical input, and which can provide a permanent or near permanent altered liquid crystal state in response thereto.

Accordingly the present invention provides a method of facilitating the alteration of a liquid crystal alignment layer disposed adjacent a liquid crystal material from a first to a second state by the action of incident light of at least a first wavelength, wherein the alignment layer acts on the adjacent liquid crystal material to cause it to tend to adopt corresponding different first and second alignments relative to the layer, the method including the step of changing the ordering of the liquid crystal material from said first alignment while said alignment layer is altered from said first to said second state. The change in ordering of the liquid crystal material includes a reduction in the degree of ordering, including at one extreme complete destruction of the liquid crystal ordering, and/or adoption at least in part of a different sort of liquid crystal ordering, for example between homeotropic and homogeneous alignments, or between two differently directed homogeneous alignments.

The invention extends to a method of changing the alignment of a liquid crystal material adjacent an alignment layer which layer comprises a material with an alignment which can be altered from a first to a second state by the action of incident light of at least a first wavelength, said method comprising performing the method of the preceding paragraph and permitting the liquid crystal to realign according to the state of the alignment layer.

The invention further extends to a liquid crystal device comprising liquid crystal material adjacent a liquid crystal alignment layer on a first substrate, the alignment layer comprising a material which can be altered from a first to a second state by the action of incident light of at least a first wavelength, the first and second states causing adjacent portions of the liquid crystal material to tend to adopt corresponding different first and second alignments, wherein the device includes facilitating means for causing the ordering of the liquid crystal material to be changed from said first alignment as said material of said alignment layer is altered from said first to said second state.

The changing of the liquid crystal ordering while the orientation of the alignment layer is altered may be effected in a number of ways including:

(a) disrupting the liquid crystal ordering, for example by means of a light sensitive dopant in the liquid crystal material, or by illumination of the liquid crystal material wherein this itself is light sensitive;

(b) where the liquid crystal material comprises a dichroic or dye component capable effectively of realigning in response to polarised light of at least a second wavelength the same as or different from the first wavelength, by illuminating the liquid crystal material with said polarised light of a second wavelength;

(c) by applying an electric field directed generally parallel to the substrate;

(d) by applying an electric field directed at an angle to the substrate; and

(e) combinations of (a) to (d).

In particular, none of the above methods of changing of the liquid crystal ordering necessarily requires heating and/or cooling of the liquid crystal material. It is thus possible for the liquid crystal material to remain in the mesophase temperature range throughout the changing of alignment, whether or not a temperature change is also effected. Preferably the temperature is held substantially constant.

Li Cui et al in “Photo-driven Liquid Crystal Cell with High Sensitivity”, Liquid Crystals 1999, 26 1541-1546, have disclosed a modified photo-addressed liquid crystal cell. As particularly described, the cell comprises two rubbed substrates, one bearing interdigitated electrodes and the initial alignment is tilted homeotropic. The photo-addressing step is arranged to convert the alignment layer to a second state promoting a homogeneous alignment in the adjacent liquid crystal material. The field from the electrodes is also directed for producing this homogeneous alignment, but in this case its amplitude is deliberately selected to be insufficient to cause such re-alignment by itself. It would seem that the presence of this field facilitates a photo-induced conversion of the alignment layer which is more rapid, and/or requires less optical input, compared to the case when the field is absent. Nevertheless, the graphs appear to indicate that following cessation of photo-addressing the liquid crystal material maintains the changed alignment only for a strictly limited period, and, as just noted, the electric field is selected so as not per se to cause substantial liquid crystal realignment or re-ordering.

Other features and advantages of the invention will become clear upon a reading of the appended claims, to which the reader is referred, and on consideration of the following more detailed description of embodiments of the invention, made with reference to the accompanying drawings, in which:

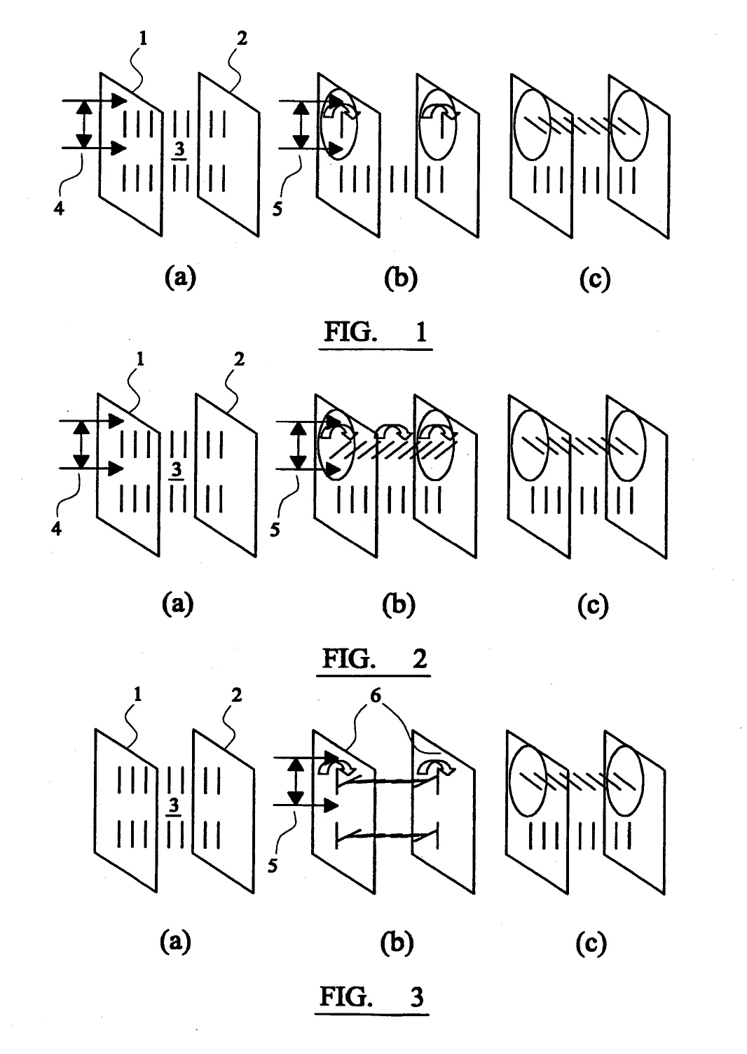

FIGS. 1 to 4 respectively illustrate in schematic form the operation of first, second, third and fourth liquid crystal devices according to the invention. Like numerals relate to like features in each of the FIGS. 1 to 4; and

FIG. 5 schematically illustrates the effective realignment of the long molecular axis of an azo molecule by incident polarised light.

The left hand part (a) of each of the Figures illustrates a device prior to photo-addressing. The device comprises two spaced substrates 1, 2 between which is disposed a layer 3 of liquid crystal material. The central part (b) of each Figure illustrates the photo-addressing of the device by local illumination 5 to alter the local state of the alignment layer, and the right hand part (c) of each Figure illustrates the device after it has been addressed and action of the facilitating means has ceased.

For ease of illustration, the liquid crystal layer has been shown as being nematic, and commencing at the left hand part of each Figure with uniform parallel (homogeneous) alignment at each substrate, the two alignments being mutually parallel. It should be noted however that the present invention is not confined to the use of nematic liquid crystal materials, but extends to mesogenic materials with other phases, including cholesteric and smectic phases. Furthermore, other starting alignments are possible, as will be discussed later.

The liquid crystal alignment at each substrate is achieved in known manner by the provision of an alignment layer comprising a dye material, as herein defined, and which has an initial state tending to impose a first alignment on the adjacent liquid crystal material. The dye is dichroic, and responds to illumination for example in the visible or near ultra-violet by changing from the first state to a second state that tends to impose a second alignment on the adjacent liquid crystal material different from the first.

In particular, the dye could be selected such as to be capable of undergoing cis-trans-isomerism in response to illumination in the near ultra-violet, whereby upon being exposed to illumination with a predetermined plane of polarisation the molecules thereof are capable of adopting a preferred orientation relative to the plane of polarisation.

FIG. 1 illustrates a device in which the liquid crystal material contains or is formed of a material which reacts to incident illumination (shown as a local beam 4) to disrupt or reduce the ordering of the liquid crystal phase, for example a suitable dye as herein defined. This incident illumination may or may not have wavelength(s) corresponding to that for controlling the state of the alignment layer, and is not necessarily polarised unless the two wavelengths correspond. The material which disrupts the liquid crystal ordering may be such as undergoes a cis-trans isomerisation. The speed at which disruption of the liquid crystal ordering is attained may be around the same, or significantly slower or faster, relative to the change of state of the alignment layers, and this may have an effect on the commencement and duration of the beams 4 and 5. If disruption is sufficiently fast, beams 4 and 5 could be applied simultaneously. There is normally no requirement for beam 4 to continue after cessation of the beam 5.

However, taking as an example a case where disruption is relatively slow, beam 4 will be applied first. Once the liquid crystal ordering has been disrupted or weakened, re-orientation of the dye molecules in the alignment layers is energetically easier, and accordingly the device is now written or addressed with polarised illumination 5 selected to enable cis-trans isomerism of the dye, and re-orientation of the molecules thereof. In particularly preferred embodiments, this illumination consists of wavelengths in at least two distinct wavebands, selected for increasing the efficiency of the re-orientation process. As shown, the re-orientation is such as to cause the adjacent liquid crystal material to have a planar alignment at substantially 90° to the starting orientation, although other angles are possible, and angles in the region of 45° may often be preferred.

Finally, both illumination 4 and illumination 5 are terminated leaving optically addressed portions of the device with a parallel alignment throughout the liquid crystal layer 3 at an angle to the original alignment. This change in alignment can be used in any manner known per se, for example using polarising optics to provide an optical intensity variation.

FIG. 2 illustrates a device similar to that of FIG. 1 but in which the liquid crystal material itself is or includes a component which can be re-orientated under incident polarised illumination 4′, and as particularly illustrated the component is a dichroic dye which undergoes cis-trans isomerisation. The speed of isomerisation of the dichroic dye may be similar to, or different from, that of the dye of the alignment layer, and again this may have an effect on necessary timings and durations of the beams 4 and 5. In one form of device the dye in the liquid crystal material and that in the alignment layer are identical, and the spectra of beams 4 and 5 may also be identical, or at least contain similar wavelengths active for their respective purposes. The component of FIG. 1 which disrupts the liquid crystal ordering is not present.

In this embodiment, realignment of the liquid crystal material and the molecules of the alignment layer can proceed co-operatively, hence reducing the energy required for successful realignment.

In general, considerations relating to wavelengths of the illumination controlling the dye re-orientation and the re-orientating component of the liquid crystal layer are similar to those for the beams 5 and 4 of FIG. 1, and the types of operation thereof are also similar.

The device of FIG. 3 comprises neither the disrupting liquid crystal layer component of FIG. 1 nor the liquid crystal layer dichroic dye component of FIG. 2, but it is otherwise similar to either of the two former devices. In FIG. 3, each substrate is provided with an electrode 6 for applying an electric field across the liquid crystal layer, and producing a generally homeotropic alignment across the layer, with the possible exception of the alignment immediately adjacent each substrate. The reduction in necessary energy facilitates realignment of the dye component of the two alignment layers by the polarised beam 5, so that after removal of the beam and cessation of the field, the addressed portions of layer 3 have a different mutually parallel alignment from the unaddressed portion.

If required, the electrodes 6 may be subdivided for selective addressing of regions of the liquid crystal layer.

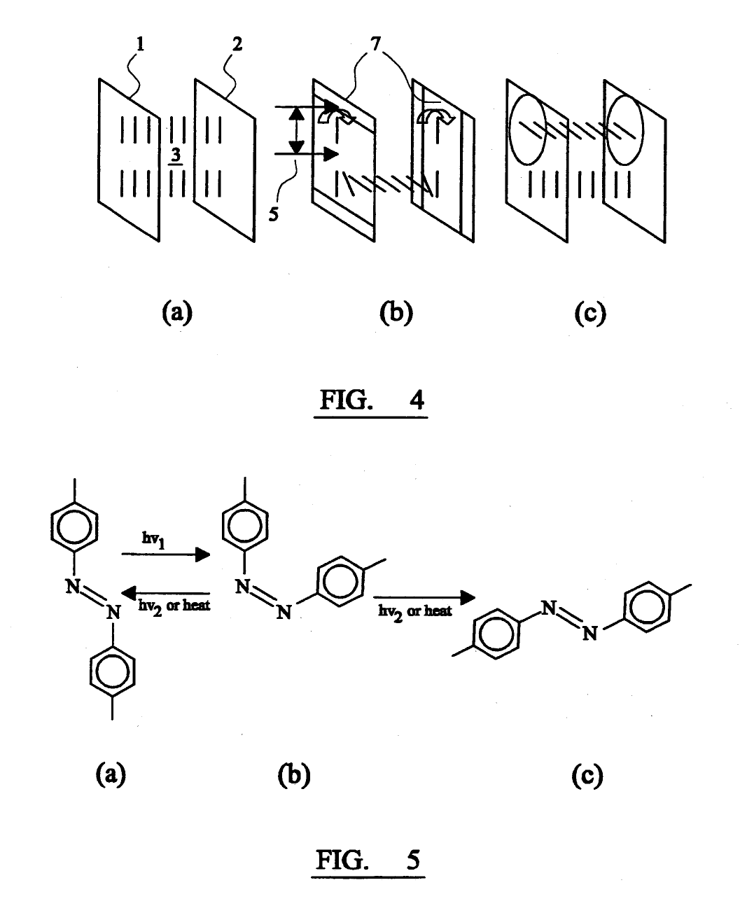

Replacement of the electrodes 6 of FIG. 3 by electrodes 7 for applying an electric field parallel to the plane of the liquid crystal layer gives the device shown in FIG. 4. As illustrated, the electrodes 7 comprise a pair of electrode strips on opposed edges of the substrate 1, and a pair of electrode strips on opposed edges of the substrate 2 out of register with those on substrate 1, e.g. orthogonal as shown. In practice each pair of strips shown may be parts of a pair of interdigitated electrodes distributed over the substrate.

Application of an electric field above a threshold level at a single substrate re-orientates the adjacent liquid crystal alignment, which remains generally homogeneous but produces a twist in the alignment across the liquid crystal layer, and so reduces the energy required for beam 5 to re-orientate the dye in the alignment layers on both substrates. Reversal to the original liquid crystal alignment may be accomplished in a similar manner by use of the interdigitated electrodes on the other substrate, and application of an appropriately polarised beam 5.

Switching in one direction only, for example from a uniform alignment, would be facilitated by having the electrodes on one substrate in register with those on the other substrate. Furthermore, if the reorientation of the adjacent liquid crystal by the applied field is arranged to be at some angle to both the initial and final orientations, for example at 45°, it would be possible to apply a twist for writing and erasing operations.

It will be clear that other arrangements of interdigitated electrodes on one or both substrates may be provided according to switching requirements and the use of beams 5 of differing polarisations.

Furthermore, addressing of both electrodes of a pair can be implemented when, for example, it is required to produce a field across the liquid crystal layer. Alternatively, continuous electrodes may be used in place of, or in addition to interdigitated electrodes—for example, one substrate may bear one an interdigitated electrode patterns and the other may comprise a continuous electrode layer, whereby it becomes possible to apply a field across the layer, or parallel to the layer at one substrate.

It should be appreciated that the four illustrated methods of constructing and operating a liquid crystal device according to the invention are not mutually exclusive, and that combinations thereof may be employed. For example, re-orientation of the liquid crystal layer component of FIG. 2 may be employed together with the use of a plane-parallel field according to FIG. 4.

A modification which can be applied to any of the arrangements so far described is for the liquid crystal material to include a dopant in the form of an oligomer, as described for example in “Weak Surface Anchoring of Liquid Crystals” by G P Bryan-Brown et al in Nature, 399 (May 27, 1999), 338-340.

It is believed that the oligomer molecules, which are much larger than the liquid crystal molecules tend to concentrate near the substrate(s) and provide what is described as a “slippery surface”. The resulting reverse directed concentration gradient of the liquid crystal phase away from the substrate(s) is believed to reduce the interaction between the alignment layer and the liquid crystal material, and accordingly both reduces the energy required to change the state of the alignment layer, thus giving the possibility of reducing the optical input even further, and also reducing the energy required to alter the alignment of the adjacent liquid crystal material from that induced by the alignment layer.

Particularly where alteration of the liquid crystal alignment occurs at a different rate from re-orientation of the alignment layer, these two phases of the overall process may commence and/or terminate at different times. An important consideration is that the liquid crystal ordering is or remains changed while the alignment layer is re-orientated.

For example, where the liquid crystal material comprises a dopant which can be optically altered so as to disrupt the liquid crystal ordering, but latter requires a relatively long time to accomplish, it would be necessary to commence illumination to activate the dopant prior to effective re-orientation of the alignment layer. Furthermore, where the altered liquid crystal ordering has a relatively long lifetime, action to provide such alteration may either continue, or have been terminated, by the time that re-orientation of the alignment layer commences. By contrast, where alteration of the liquid crystal ordering and re-orientation of the alignment layer are both relatively rapid, it will be convenient to perform both phases of the process simultaneously.

It should be noted that since realignment by beam 5 occurs easily only when the facilitating means is also operative, various modes of operation are possible.

For example, it would be possible to replace an overall illuminating beam 4 of FIG. 1 or FIG. 2 by a beam which addresses only selected regions of the device at any time (either a static beam or a scanned beam). This could be of use in reducing the power requirements for beam 4, and applies irrespective of whether beams 4 and 5 are of mutually exclusive wavelengths.

Likewise, the beam 5 could be applied to all the selected regions of the device to be written simultaneously, or to all pixels in sequentially selected (or scanned) areas, or pixel sequentially, as by scanning. However, these types of operation do slow down the addressing of the entire device, compared with overall illumination by beam 4 and parallel addressing by beam 5.

Also since both conditions must be present, it is possible to logically AND the (local) application of the facilitating means, whether electrical or optical, with the (local) alignment layer addressing beam 5. Thus when they are of mutually exclusive wavelengths, the necessary ANDing of beams 4 and 5 in FIGS. 1 and 2 could also prove useful in logic or other optical devices.

It should also be appreciated that other initial and final liquid crystal alignments are possible. The following list provides a number of possible examples:

1. Rotation of a Splayed State

| | |
|---|---|
| Substrate 1 | alignment layer photo-addressable between planar and |
| | planar states |
| Substrate 2 | normal homeotropic alignment layer |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) in-plane electrodes on each substrate for fields in |
| | different direction (e.g. non-registering electrodes as in |
| | FIG. 4) |

2. Switching Between Uniform Planar and Twisted States

| | |
|---|---|
| Substrate 1 | alignment layer photo-addressable between planar and |
| | planar states |
| Substrate 2 | normal planar alignment layer |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) In-plane electrodes on substrate 1, or on both substrates |
| | so as to provide parallel electric fields at the two substrates |
| | (e.g. registering electrodes), with the energy in the twisted |
| | state promoting return to the uniform planar state. |
| | (e) In-plane electrodes on both substrates so as to provide |
| | relatively inclined, e.g. normally directed (non-registering |
| | electrodes, as in FIG. 4), fields at the two substrates. |

3. Rotation of Uniform Planar State

| | |
|---|---|
| Substrate 1 | alignment layer photo-addressable between planar and |
| | planar states |
| Substrate 2 | alignment layer photo-addressable between planar and |
| | planar states |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) In-plane electrodes on each substrate, providing |
| | relatively inclined, e.g. normally directed, electric fields at |
| | the two substrates (e.g. as in FIG. 4). |

4. Switching Between Uniform and Splayed States

| | |
|---|---|
| Substrate 1 | alignment layer photo-addressable between planar and |
| | homeotropic states |
| Substrate 2 | normal planar alignment layer with alignment parallel to the |
| | planar alignment on substrate 1 |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) In-plane electrodes on substrate 1 only, with the energy |
| | in the splayed state promoting return to the uniform planar |
| | state. |
| | (e) In-plane electrodes on substrate 1 only, electrode for |
| | field normal to the layer on substrate 2. |
| | (f) Electrodes on both substrates providing parallel fields |
| | (e.g. registering electrodes). |

5. Switching Between Twisted and Splayed States

| | |
|---|---|
| Substrate 1 | alignment layer photo-addressable between planar and |
| | homeotropic states |
| Substrate 2 | layer for normal planar alignment perpendicular to the |
| | planar alignment on substrate 1. |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) In-plane electrodes on each substrate for fields in |
| | different direction (e.g. non-registering electrodes as in |
| | FIG. 4) |
| | (e) In-plane electrodes on substrate 1 only, electrode for |
| | field normal to the layer on substrate 2. |

6. Switching Between Homeotropic and Splayed States

| | |
|---|---|
| Substrate 1 | alignment layer photo-addressable between planar and |
| | homeotropic states |
| Substrate 2 | normal homeotropic alignment layer |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) In-plane electrodes on substrate 1 only, with the energy |
| | in the splayed state promoting return to the uniform planar |
| | state. |
| | (e) In-plane electrodes on substrate 1 only, electrode for |
| | field normal to the layer on substrate 2. |
| | (f) Electrodes on both substrates providing parallel fields |
| | (e.g. registering electrodes). |

7. Switching Between Homeotropic and Uniform Planar States

| | |
|---|---|
| Substrate 1 | alignment layer photo-addressable between planar and |
| | homeotropic states |
| Substrate 2 | alignment layer photo-addressable between planar and |
| | homeotropic states |
| Options | (a) Liquid crystal layer with orientation disrupting dopant |
| | (as FIG. 1) |
| | (b) Liquid crystal layer with orientation realigning dopant |
| | (as FIG. 2) |
| | (c) Electrodes on each substrate for normal electric field |
| | (as FIG. 3) |
| | (d) in-plane electrodes on each substrate for fields in the |
| | same direction (e.g. registering electrodes). |

Any of these devices may be constructed in which the liquid crystal material comprises chiral dopants either so as to generate super twisted states, or to stabilise twisted states relative to splayed or planar states, in a manner known per se. At least some of these devices are capable of providing a grey-scale display, or multi-level (greater than binary) information storage.

1. A method of facilitating the alteration of a liquid crystal alignment layer disposed adjacent a liquid crystal material from a first stable state to a second stable state by the action of incident light of at least a first wavelength, wherein the alignment layer acts on the adjacent liquid crystal material to cause it to tend to adopt corresponding different first and second alignments relative to the layer, the method including the step of changing the ordering of the liquid crystal material from said first alignment, while in the liquid crystal phase temperature range, while said alignment layer is altered from said first to said second state.

2. A method according to claim 1 wherein said step comprises applying an electric field directed generally parallel to the alignment layer.

3. A method according to claim 1 wherein said step comprises applying an electric field directed at an angle to the substrate.

4. A method according to claim 3 wherein said angle is substantially 90°.

5. A method according to any preceding claim wherein said step includes disrupting the liquid crystal ordering.

6. A method according to any one of claims 1 to 4 wherein the liquid crystal material comprises a dichroic component capable effectively of realigning or re-ordering in response to polarised light of at least a second wavelength the same as or different from the first wavelength, and said step includes illuminating the liquid crystal material with said polarised light of a second wavelength.

7. A method according to any preceding claim wherein said incident light of at least one wavelength is applied only to selected regions of the alignment layer.

8. A method according to preceding claim and comprising the further step of altering the second state of the alignment layer to a third state which is the same as, or different from, the first state.

9. A method according to any preceding claim wherein said light of at least said first wavelength has a predetermined polarisation.

10. A method according to claim 9 and claim 10 wherein alteration to the third state is accomplished with light of the said first wavelength with a polarisation different from said predetermined polarisation.

11. A method according to any preceding claim wherein the liquid crystal material comprises an oligomeric dopant.

12. A method of changing the alignment of a liquid crystal material adjacent an alignment layer which layer comprises a material with an alignment which can be altered from a first to a second state by the action of incident light of at least a first wavelength, said method comprising performing the method according to any preceding claim and permitting the liquid crystal to realign according to the state of the alignment layer.

13. A liquid crystal device comprising liquid crystal material in contact with a liquid crystal alignment layer on a first substrate, the alignment layer comprising a material which can be altered from a first stable to a second stable state by the action of incident light of at least a first wavelength, the first and second states causing adjacent portions of the liquid crystal material to tend to adopt corresponding different first and second alignments, wherein the device includes facilitating means for causing the ordering of the liquid crystal material to be changed from said first alignment, while in the liquid crystal phase range, as said material of said alignment layer is altered from said first to said second state.

14. A liquid crystal device according to claim 13 wherein said facilitating means includes in-plane electrodes adjacent said first substrate, and a source of potential difference for coupling between said electrodes to provide a field sufficient to change the ordering of the liquid crystal material from said first alignment.

15. A liquid crystal device according to claims 13 or claim 14 wherein said facilitating means includes means for causing the liquid layer to adopt a homeotropic alignment.

16. A liquid crystal device according to any one of claims 13 to 15 wherein the liquid crystal material includes a component which on illumination with at least a second wavelength undergoes a transformation which disrupts the liquid crystal phase, said facilitating means including a source of light of said at least said second wavelength.

17. A liquid crystal device according to claim 16 wherein said second wavelength is substantially optimised for causing said transformation.

18. A liquid crystal device according to any one of claims 13 to 15 wherein the liquid crystal material includes a component the alignment of which affects the ordering of the liquid crystal phase and which component on illumination with polarised light of at least a second wavelength adopts a preferred alignment, said facilitating means including a source of said at least said second wavelength.

19. A liquid crystal device according to claim 18 wherein said second wavelength is substantially optimised for causing said adoption of a preferred alignment.

20. A liquid crystal device according to any one of claims 16 to 19 wherein the first and second wavelengths are substantially the same.

21. A liquid crystal device according to any one of claims 16 to 19 wherein the first and second wavelengths are different.

22. A liquid crystal device according to any one of claims 13 to 21 wherein at least one of said first and second alignments is planar.

23. A liquid crystal device according to claim 22 wherein said at least one planar alignments is said second alignment.

24. A liquid crystal device according to claim 22 or claim 23 wherein the other of said first and second alignments is planar.

25. A liquid crystal device according to claim 22 or claim 23 wherein the other of said first and second alignments is homeotropic.

26. A liquid crystal device according to any one of claims 13 to 25 wherein the liquid crystal material provides a liquid crystal layer between said first substrate and a second opposed substrate.

27. A liquid crystal device according to claim 15 and claim 26 wherein said causing means comprises an electrode on each of said first and second substrates.

28. A liquid crystal device according to claim 26 or claim 27 wherein the portion of the liquid crystal layer adjacent the second substrate has a homeotropic alignment.

29. A liquid crystal device according to claim 26 or claim 27 wherein the portion of the liquid crystal layer adjacent the second substrate has a planar alignment.

30. A liquid crystal device according to claim 22 and claim 29 wherein the planar alignment adjacent the second substrate is parallel to that adjacent the first substrate in said at least one alignment state.

31. A liquid crystal device according to claim 22 and claim 29 wherein the planar alignment adjacent the second substrate is inclined to that adjacent the first substrate in said at least one alignment state.

32. A liquid crystal device according to any one of claims 26 to 31 wherein the second substrate is provided with a liquid crystal alignment layer comprising a material with an alignment which can be altered between first and second different directions by the action of incident light of at least a third wavelength, which may or may not be different from said first wavelength.

33. A liquid crystal device according to claim 32 wherein said first direction induces planar alignment.

34. A liquid crystal device according to claim 33 wherein said second direction induces planar alignment.

35. A liquid crystal device according to claim 33 wherein said second direction induces homeotropic alignment.

36. A liquid crystal device according to any one of claims 13 to 35 and including a source of said light of at least said first wavelength.

37. A liquid crystal device according to claim 36 wherein said incident light of at least a first wavelength includes light in at least two distinct wavebands, each capable of causing said alteration from a first to a second orientation.

38. A liquid crystal device according to claim 36 or claim 37 and including means for locally addressing portions of said alignment layer with said light of at least said first wavelength.

39. A liquid crystal device according to any one of claims 13 to 38 wherein the liquid crystal material comprises a chiral dopant.

40. A liquid crystal device according to any one of claims 13 to 39 wherein the chiral dopant stabilises a twisted state relative to a splayed or planar state.

41. A liquid crystal device according to any one of claims 13 to 40 wherein the liquid crystal layer has a super twisted state.

42. A liquid crystal device according to any one of claims 13 to 41 wherein a said material with an state which can be altered by the action of incident light undergoes cis-trans isomerism in response to said incident light.

43. A liquid crystal device according to any one of claims 13 to 42 wherein a said material with a state which can be altered by the action of incident light is an azo dye, a Schiff base, or a stilbene.

44. A liquid crystal device according to any one of claims 13 to 43 wherein the liquid crystal material comprises an oligomeric dopant.

45. A liquid crystal device substantially as hereinbefore described with reference to any one of FIGS. 1 to 4 of the accompanying drawings.

46. A method of facilitating the realignment of a liquid crystal alignment layer substantially as hereinbefore described with reference to any one of FIGS. 1 to 4 of the accompanying drawings.

47. A method of changing the alignment of a liquid crystal material substantially as hereinbefore described with reference to any one of FIGS. 1 to 4 of the accompanying drawings.
